(19) United States
(12) Patent Application Publication
(10) Pub. No.: US 2012/0013189 A1
(43) Pub. Date: Jan. 19, 2012

(54) BATTERY MANAGEMENT SYSTEM

(75) Inventor: Jeffrey Jenkins, Tampa, FL (US)

(73) Assignee: VERCINGETORIX, LLC, Saint Petersburg, FL (US)

(21) Appl. No.: 12/836,780

(22) Filed: Jul. 15, 2010

(51) Int. Cl. H02J 7/00; G01N 27/416

(52) U.S. Cl. 307/80; 324/434

(57) ABSTRACT

An application for a battery management system that monitors current and voltage from one or more battery cells and determines if the current is above or below a predetermined value. If the current is below the predetermined value (e.g. a load from a few lights, etc), the battery management system disconnects the battery cells from the load when the voltage falls below a higher voltage threshold (e.g. 12V). If the current is above the predetermined value (e.g. a load from a starter motor cranking an engine), the battery management system disconnects the battery cells from the load when the voltage falls below a lover voltage threshold (e.g. 8V). Once disconnected a reset signal is required to reconnect the battery cell(s) to the load.

### FIELD

This invention relates to the field of batteries and more particularly to a system for providing management of a battery pack along with improved starting capabilities.

### BACKGROUND

Battery packs such as flooded lead-acid, absorbed-glass-matt (AGM) and lead-acid are often used in applications where there are periodic high-current demands on the pack. For example, lead acid battery packs containing six 2V cells in series have been used for many years in vehicles such as automobiles, boats, etc. While the vehicle's engine is running, most of the vehicle's electric demand is satisfied by the alternator while the battery packs are charged by any excess power from the alternator. When the engine is not running, all of the power needed by the vehicle is supplied by the battery pack.

Lead acid batteries have the advantage of low cost and are typically not seriously damaged by depletion of charge. Therefore, if a vehicle is left with a significant power draw for a long period of time (e.g. lights left on), the lead acid battery will still accept a recharge and, after some charge has been added, the pack will support starting of the vehicle.

More recently, new battery packs have been introduced that use different chemistries having various advantages such as lower weight, better operating temperature ranges, etc. For example, flooded lead-acid, absorbed-glass-matt (AGM) and various types of Lithium Ion battery packs are being used in certain automotive applications. Some vehicles are using a lithium ion pack having cells arranged in 4-serial, 5-parallel (4S5P) to deliver an output voltage that is very similar to that of the typical lead acid automotive battery (e.g. 14.4V with minimal load). Many of such battery packs are not tolerant to various conditions such as over-voltage, under-voltage and high temperatures. Many types of battery cells suffer irreversible damage when allowed to discharge below a certain voltage or when allowed to exceed a certain temperature. Being that these battery packs are often significantly more expensive than the lead acid packs that they are supplanting, it is important that the packs prevent over heating of the cells, exceeding maximum voltage as specified by the manufacturer, dropping below a minimum voltage as specified by the manufacturer, etc.

Another problem occurs when current is drained from the battery in between uses of the vehicle in which they are installed. For example, many newer vehicles have computer systems that draw several watts even when the vehicle isn't operating. After several weeks or months, without proper battery management, this low power draw will eventually deplete the battery pack to a level in which damage occurs. Another example is when one leaves their lights on while the vehicle is parked. This draws hundreds of watts and, after hours, without proper battery management, this higher power draw will eventually deplete the battery pack to a level in which damage occurs.

Another problem occurs when a vehicle is left for many days without use (as often occurs in sport vehicles) or a higher current draw is consumed for a shorter period of time, lowering the charge in the battery pack to a level where no damage has occurred, but the total available charge is insufficient to start the vehicle, requiring a recharge or “jump” to start the engine and, eventually, fully recharging the battery pack.

What is needed is a battery management system that will protect the battery cells from damage and help ensure sufficient charge is available to start the vehicle.

### SUMMARY

A battery management system monitors current and voltage from one or more battery cells and determines if the current is above or below a predetermined value. If the current is below the predetermined value (e.g. a load from a few lights, etc), the battery management system disconnects the battery cells from the load when the voltage falls below a higher voltage threshold (e.g. 10V or 12V). If the current is above the predetermined value (e.g. a load from a starter motor cranking an engine), the battery management system disconnects the battery cells from the load when the voltage falls below a lover voltage threshold (e.g. 8V). Once disconnected a reset signal is required to reconnect the battery cell(s) to the load. This system reduces the risk of a totally discharged battery in applications where it is desirable to maintain sufficient charge as to, for example, start a vehicle engine.

The disclosed battery management system complies with UN/DOT transportation considerations such as section 38.3 for lithium batteries as published by the International Air Transportation Association (IATA).

In one embodiment, a battery management system is disclosed including circuitry for switchably connecting one or more battery cells to a load, circuitry for measuring a current between the battery cells and the load and circuitry for measuring a voltage over the battery cells. A circuit determines if the current is below a predetermined value and the voltage is below a higher threshold, thereby the circuit electrically disconnects the battery cells from the load by the circuitry for switchably connecting when the current is below the predetermined value and the voltage is below the higher threshold. A circuit also determines if the current is above the predetermined value and the voltage is below a lower threshold, thereby the circuit electrically disconnecting the battery cells from the load by the means for switchably connecting when the current is above the predetermined value and the voltage is below the lower threshold.

In another embodiment, a method of managing one or more battery cells is disclosed including (a) electrically connecting the battery cells to a load and (b) measuring an electric current from the battery cells to the load. (c) if the electric current is greater than a predetermined value: (d) starting a timer; (e) if the electric current is still greater than the predetermined load and a voltage over the battery cells is greater than a lower threshold, repeating from step (a); (f) if the timer has not expired, repeating steps (e)-(f); otherwise (g) electrically disconnecting the battery cells from the load; then (h) waiting until a reset occurs; then (i) repeating from step (a). (j) If the electric current is less than the predetermined value: (k) starting the timer; (l) if the electric current is still less than the predetermined load and the voltage over the battery cells is greater than a higher threshold, repeating from step (a); (m) if the timer has not expired, repeating steps (l)-(m); otherwise (n) electrically disconnecting the battery cells from the load; (o) waiting until a reset occurs; then (p) repeating from step (a).

In another embodiment, a battery management system is disclosed including one or more transistors connected in series between a plurality of battery cells and a load, a sensor for measuring an electric current between the battery cells and the load and a sensor for measuring a voltage over the battery cells. A processor is connected to the transistors for connecting and disconnecting the load and the battery cells. The processor is also connected to the sensor for measuring the electric current and the sensor for measuring the voltage and the processor has stored values for a lower voltage threshold and a higher voltage threshold. Software running on the processor determines if the electric current is below a predetermined value and if the voltage is below the higher threshold voltage and signals the transistors to disconnect the battery cells from the load when the electric current is below the predetermined value and the voltage is below the higher voltage threshold and the software also determines if the electric current is above the predetermined value and the voltage is below the lower voltage threshold and signals the transistors to disconnect the battery cells from the load when the electric current is above the predetermined value and the voltage is below the lower voltage threshold.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a battery pack with internal battery management.

FIG. 2 illustrates a schematic view of a battery management system.

FIG. 3 illustrates an exemplary block diagram of typical battery management system controller.

FIG. 4 illustrates an operational graph of the battery management system.

FIG. 5 illustrates an exemplary flow chart of the battery management system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

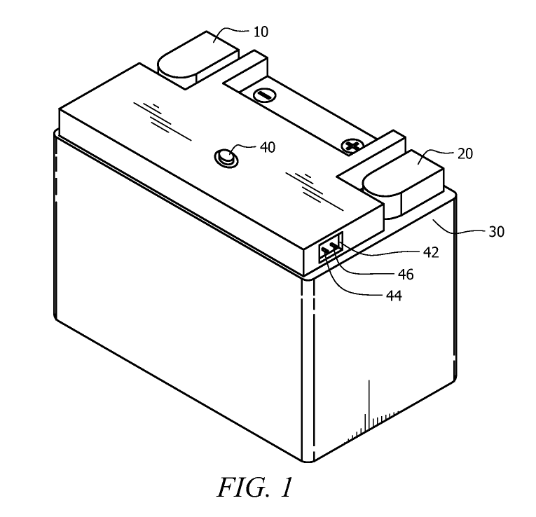

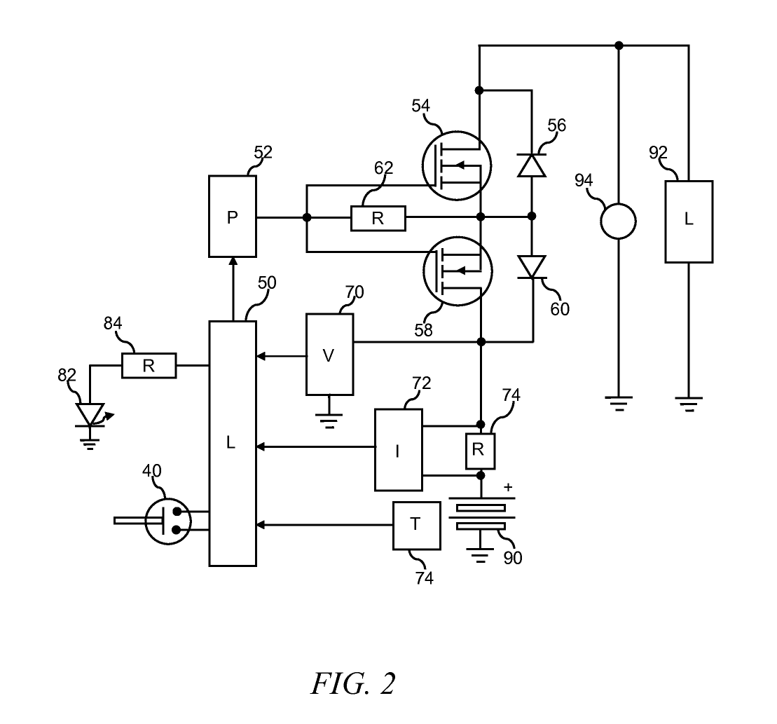

Referring to FIG. 1, a perspective view of a typical battery pack 30 is shown. Many battery packs 30 (e.g. flooded lead-acid, absorbed-glass-matt (AGM), lead-acid, lithium ion, nickel metal hydride and lead-acid derivative) has one or more internal battery cells 90 (see FIG. 2). Power from the internal battery cells is routed to/from a positive 20 and negative 10 battery terminal for connection to, for example, a vehicle power system.

In a typical use, the battery 30 has several typical modes of operation. In starting mode, the battery 30 is called upon to deliver, for example, hundreds of amperes of current to a starter motor. In running mode (e.g. the vehicle engine is running), the battery pack 30 receives several amperes of charge from the vehicle's alternator (or generator). In accessory mode, the vehicle draws anywhere from zero amperes up to tens of amperes from the battery pack 30 to power, for example, lights, indicators, vehicle computer systems, etc.

This battery pack 30 has one or more internal battery cells 90 (not visible, see FIG. 2), an internal battery management circuit (not visible, see FIGS. 2, 3 and 5), an optional reset switch/indicator 40 and an optional external reset/indicator connector 42 with connection pins 44/46.

The operation of the battery management system is such that, the battery management system monitors the internal battery voltage (voltage across the battery cells 90), the current being drawn and the temperature of the battery cells to determine when the battery cells need be disconnected from the battery terminals 10/20 to prevent failure of the battery cells 90 and/or to retain sufficient charge as to enable at least one attempt to start the vehicle after the disconnection is reset. Once the disconnection is triggered, an optional indicator 82 (see FIG. 2), often integrated into the reset button 40, is illuminated (either an indicator integrated with a reset switch 40) as shown, a separate indicator or remote indicator—not shown. To reset and reconnect the battery pack, a reset switch (e.g. push button switch 40 or a remote reset switch—not shown) is pressed/operated to signal the battery management system to reapply power to the output terminals 10/20. Of course, if the same situation that caused the trigger is still active, the disconnect will trigger again after a predetermined interval.

Any of several situations trigger the disconnect. If the voltage over the battery cells 90 reaches an over voltage threshold or an under voltage threshold, if too much current is drawn or if the cells 90 reach an unsafe temperature (e.g. during charging), the disconnect is triggered.

In order to provide sufficient power while also protecting the battery cells 90, the battery management system monitors the current draw and implements different voltage thresholds depending upon the current draw. For example, with a certain lithium ion battery cell arranged in a 4SXP (4 serial any number parallel) configuration, the battery cells 90 will be damaged if the pack voltage goes below 8V (less than 2V per cell). Therefore, the disconnect is tripped under any current load when the voltage falls to 8V (lower voltage threshold), in some embodiments, for a predetermined interval. The discharge of such battery cells 90 is, for example, substantially linear between around 13V and 8V (e.g. at 10.5V, the battery cells 90 hold approximately ½ of their capacity), falling off sharply when down to the last few percent of capacity. A higher voltage threshold is at, for example, 12V. At this voltage, the battery cells 90 hold a little less than ½ of their fully charged power. When the current draw is less than a predetermined value (e.g. a few ampere to power the vehicle computer and some indicator lights) and the cell voltage goes below this higher threshold, the disconnect is tripped, leaving enough power in the battery cells 90, for example, to start the vehicle engine. When the current draw is greater than the predetermined value, the disconnect is not tripped until the voltage over the battery cells 90 drops to the lower threshold (e.g. 8V). Therefore, if the vehicle is stored for several months, drawing a few ampere for the vehicle computer, when the owner tries to start the vehicle, it doesn't start because the cell voltage dropped to less than, for example, 12V, and the disconnect was tripped. But, after pressing the reset 40, the battery cells 90 are reconnected to the vehicle and there is potentially enough of a charge remaining to start the vehicle's engine (depending on starter motor draw, temperature, etc).

Referring to FIG. 2, a schematic view of a battery management system will be described. The battery management system monitors the internal battery voltage (voltage across the battery cells 90) with a voltage measurement device 70 such as one or more comparators. The battery management system monitors the current being drawn from the battery cells 90 with a current sensor 72. In one embodiment, the current sensor 72 measures a voltage drop over a very low resistance 74 such as a path on a circuit board of known width, thickness and length. The temperature of the battery cells is measured by a temperature sensor 74. A logic circuit or controller 50 has as inputs the values from the voltage measurement 70, current measurement 72 and temperature 74. The logic/controller 50 determines when the battery cells need be connected or disconnected from the load 92 or charging source 94 (e.g. alternator) that are connected to the battery terminals 10/20. When the logic/controller 50 determines that it is safe to flow current, the logic/controller enables the charge pump 52 and the charge pump 52 drives the gates of two or more pairs of transistors (FET) 54/58, preferably into saturation, thereby minimizing voltage drop across the transistors and power consumed by the transistors.

One of the transistors 54 passes current into the battery cells 90 through a diode 60 from a charging source 94 (e.g. an alternator) The other transistor 58 passes current from the battery cells 90 through another diode 56 to the load 92 (e.g. vehicle electronics, lights, starter motor, etc).

When a disconnection is triggered, the logic/controller 50 disables the charge pump 52 and no current flows through the transistors 54/58 and diodes 56/60, thereby disconnecting the battery cells 90 from the load 92 and charge source 94.

An optional indicator 82 and switch 40 (either an indicator integrated with a reset switch 40 or a separate indicator—not shown) is interfaced to the logic/controller 50. For example, the indicator 82 internal to the indicator/switch 40 (e.g. LED) is connected to an output of the logic/controller 50 by a current limiting resistor 84 or any other known indicator and driver circuit. The logic/controller 50 drives the indicator with a positive voltage to indicate that a disconnection has been triggered. To reset and reconnect the battery cells to the load 92 and charge source 94, the reset switch 40 is pressed/operated and the logic/controller 50 re-applies power to the output terminals 10/20. If the same situation that caused the trigger is still active, the disconnect will trigger again after a predetermined interval.

Any of several situations trigger the disconnect. If the voltage measured by the voltage monitor 70 reads an over voltage threshold or an under voltage threshold or if the temperature measured by the temperature sensor 74 reaches an unsafe temperature (e.g. during charging), the disconnect is triggered. The voltage threshold is dependent upon the current measured by the current sensor 72. For example, with a certain lithium ion battery cell arranged in a 4SXP (4 serial any number parallel) configuration, the battery cells 90 will be damaged if the pack voltage goes below 8V (2V per cell). Therefore, the disconnect is tripped under any current load at a lower voltage threshold of 8V. Being that the discharge of such battery cells 90 is substantially linear between around 13V and 8V (e.g. at 10.5V, the battery cells 90 hold approximately ½ of their capacity). When the current draw is less than a predetermined current (e.g. a few ampere to power the vehicle computer and some indicator lights), the disconnect trips at a higher voltage threshold of 12V, leaving enough power in the battery cells 90, for example, to start the vehicle engine. When the current draw is greater than the predetermined value, the disconnect trips at the lower threshold (e.g. 8V), for example, during engine cranking. If the disconnect is tripped (e.g. the vehicle sat idle for months and the voltage over the battery cells 90 dropped below the higher threshold), after operating the reset 40, the battery cells 90 are reconnected to the vehicle and there is potentially enough of a charge remaining to start the vehicle's engine (depending on starter motor draw, temperature, etc).

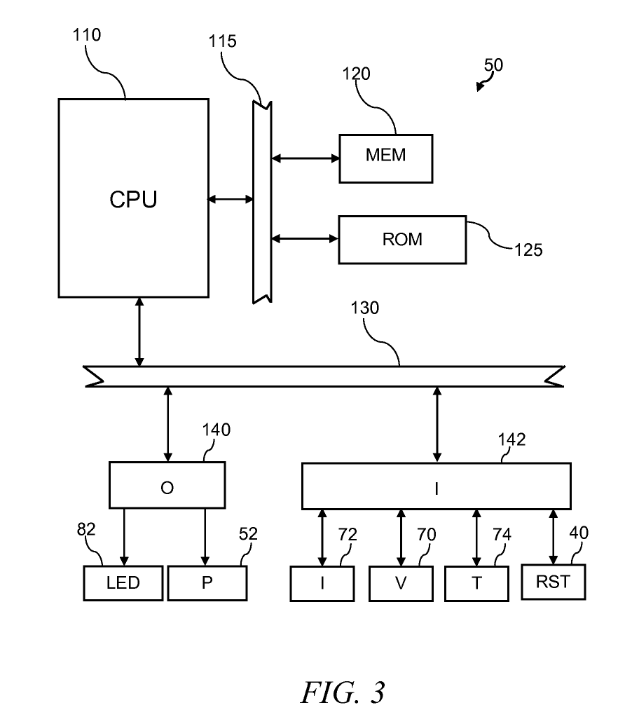

Referring to FIG. 3, an exemplary block diagram of typical battery management system controller 50 will be described. Although it is possible to fabricate the logic/controller 50 from logic gates, etc, it is preferred to utilize a controller, microcontroller, etc. A typical controller includes a central processor 110 having memory 120 and program/table/data storage 125 connected to the controller 110 by a memory bus 115. Any type of memory and program/table/data storage is anticipated including static RAM, dynamic RAM and various types of persistent memory such as ROM, EPROM, EEPROM, FLASH, etc.

A program is initially stored in the program/table/data storage 125 and begins operation when power is applied to the logic/controller 50. The program reads the values/states of the current sensor 72, voltage sensor 70, temperature sensor 74 and reset switch 40 through an input port or ports 142. The program controls the charge pump 52 (or directly controls the transistors 54/58) and controls to indicator 82 through an output port or ports 140. In some embodiments, the input ports 142 and output ports 140 are connected to the central processing unit 110 by a bus 130 (e.g. SPI bus, etc).

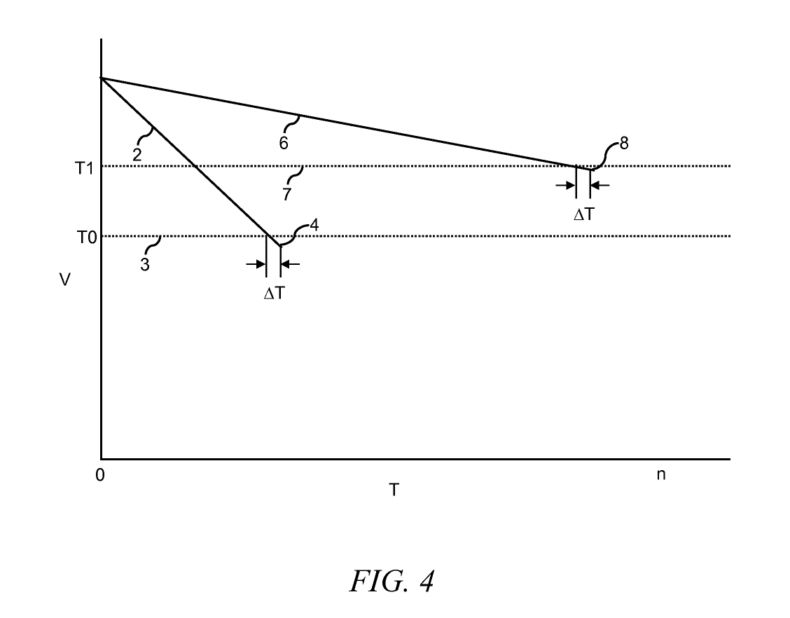

Referring to FIG. 4, an operational graph of the battery management system will be described. Voltage is shown on the X axis and time on the Y axis. Two examples of current draw are depicted by a steep sloping line 2 and a gradual sloping line 6. At the left (time, T, is 0), the battery cells 90 are charged (e.g. voltage is above both thresholds 7/3, T0 and T1). The first example of current draw depicted by a steep sloping line 2 is indicative of a high current draw such as that when a vehicle starter motor is cranking. Since the current is greater than the predetermined current value, the disconnect is not triggered when the voltage passes below the first, higher, threshold 7, T1. Rather, to protect the battery cells 90 from damage, the disconnect is triggered when the voltage from the battery cells 90 goes below the second, lower, threshold 3, T0, for longer than a period of time 4, ΔT, at a trip point 4. After the trip point 4, it is anticipated that the voltage over the battery cells 90 will raise since no current is being drawn and, therefore, it is anticipated that, in some embodiments, voltage hysteresis is provided.

The second example of current draw depicted by a gradual sloping line 6 is indicative of a low or moderate current draw such as that when a vehicle is idle and a vehicle computer and/or indicator lights are operational. Since the current is less than the predetermined current value, the disconnect is triggered when the voltage passes below the first, higher, threshold 7, T1, for longer than a period of time 4, ΔT, at a trip point 8. Note, both periods of time are either the same or different. After the trip point 8, it is anticipated that the voltage over the battery cells 90 will raise since no current is being drawn and, therefore, it is anticipated that, in some embodiments, hysteresis is provided.

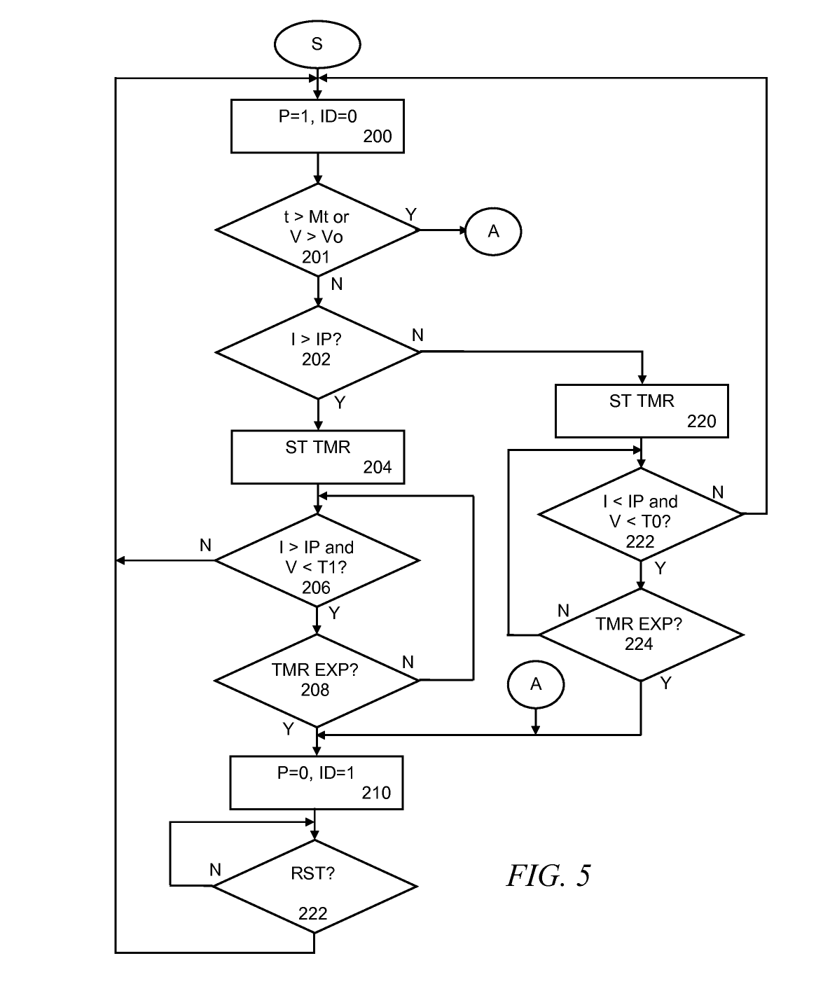

Referring to FIG. 5, an exemplary flow chart of the battery management system will be described. This flow is for when current is flowing out of the battery cells 90. When current is flowing into the battery cells 90 (e.g. current flows from the alternator 94), known charging algorithms for the battery cell 90 chemistry and specifications are implemented that control the current flow through the charge transistor(s) 54 and charge diode(s) 60 while monitoring the current 72, voltage 70 and temperature 74.

When the battery management program starts current flow out of the battery cells 90, the first step is to enable the current flow by enabling, for example, the charge pump 52 (P=1). In embodiments having an indicator 82, the indicator 82 is set to indicate no fault has occurred (e.g. ID=0). Next, the temperature of the cells, t, and the voltage of the cells, V is tested 201 and, if the temperature of the cells, t, is greater than the maximum temperature, Mt, or if the voltage of the cells, V, is greater than an overvoltage value, Vo, the current flow is disabled 210.

Next, a test is made to determine 202 if the current flow is greater than the predetermined value (I>IP). If the current flow is greater 202 than the predetermined value (e.g. cranking an engine), a timer is started 204. Next, the voltage is tested 206 to determine if the voltage is less than the lower threshold (V<T1) and if the current is still over the predetermined value (I>IP). If the current is not greater than the predetermined value (I>IP) 206 or if the voltage is greater than the lower voltage threshold (V>T1) 206, then nothing needs to be done (e.g. still plenty of charge left and no imminent damage to cells) and the above steps are repeated 200. If the current is still greater than the predetermined value (I>IP) and the voltage is still lower than the lower voltage threshold (V<T1) 206, then the timer is checked 208 to see if it has expired (e.g., the voltage has been under the lower threshold, T1, for a predetermined length of time). If the timer hasn't expired 208, the previous test 206 is repeated. If the timer has expired 208, the current flow is disabled 210 by disabling, for example, the charge pump 52 (P=0). In embodiments having an indicator 82, the indicator 82 changes status (e.g. ID=1) to indicate a fault. Next, a loop 222 is entered, waiting for the reset to be signaled (reset switch 40 is pressed or remote reset). Once the reset is signaled, the method continues with restoring the indicator to indicate no-fault and restarting current flow 200.

If the current flow is lower 202 than the predetermined value (e.g. low drain from vehicle computer, etc), a timer is started 220. Next, the voltage is tested 222 to determine if the voltage is less than the higher threshold (V<T0) and if the current is still under the predetermined value (I<IP). If it is not true that the current is under the predetermined value (I<=IP) and the voltage is still less than the higher threshold, T0, 206 then nothing needs to be done (e.g. still plenty of charge left and no imminent damage to cells) and the above steps 200 are repeated. If the current is still under the predetermined value (I<=IP) and the voltage is lower than the higher threshold (V<T0) 222, then the timer is checked 224 to see if it has expired (e.g., the voltage has been under the higher threshold, T0, for a predetermined length of time). If the timer hasn't expired 224, the previous test 222 is repeated. If the timer has expired 224, the current flow is disabled 210 by disabling, for example, the charge pump 52 (P=0). In embodiments having an indicator 82, the indicator 82 is changed (e.g. ID=1) to indicate a fault. Next, a loop 222 is entered, waiting for the reset to be signaled (reset switch 40 is pressed or remote reset). Once the reset is signaled, the method continues with restoring the indicator to indicate no-fault and restarting current flow 200.

The timers are optional and provide a level of hysteresis such that, the voltage needs to drop below the corresponding threshold (T0 or T1) for a predetermined time period (e.g. 200 ms) before the disconnect is triggered. It is anticipated that, in some embodiments, there are more than two thresholds. It is also anticipated that, in some embodiments, there is interaction between the thresholds, T0 and T1, and the temperature, especially with battery cell chemistry that is very sensitive to temperature. It is also anticipated that, in some embodiments, algorithms are included to remember a previous discharge cycle and, if the discharge almost triggered the disconnect, the timer values are adjusted to trigger the disconnect earlier or later as needed.

Other faults such as exceeding a maximum voltage or exceeding a maximum current are also anticipated but not addressed in the above description for clarity reasons.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A battery management system comprising:
means for switchably connecting one or more battery cells to a load;
means for measuring a current between the battery cells and the load;
means for measuring a voltage over the battery cells;
means for determining if the current is below a predetermined value and the voltage is below a higher threshold, thereby electrically disconnecting the battery cells from the load by the means for switchably connecting when the current is below the predetermined value and the voltage is below the higher threshold; and
means for determining if the current is above the predetermined value and the voltage is below a lower threshold, thereby electrically disconnecting the battery cells from the load by the means for switchably connecting when the current is above the predetermined value and the voltage is below the lower threshold.

2. The battery management system of claim 1, wherein the means for determining if the current is below the predetermined value and the voltage is below a higher threshold includes a timer and disconnecting the battery cells from the load by the means for switchably connecting is performed when the current is below the predetermined value and the voltage is below the higher threshold for an interval determined by the timer.

3. The battery management system of claim 1, wherein the means for determining if the current is above the predetermined value and the voltage is below a lower threshold includes a timer and disconnecting the battery cells from the load by the means for switchably connecting is performed when the current is above the predetermined value and the voltage is below the lower threshold for an interval determined by the timer.

4. The battery management system of claim 1, wherein the means for switchably disconnecting is one or more transistors.

5. The battery management system of claim 4, wherein the transistors are driven into saturation by a charge pump.

6. The battery management system of claim 1, wherein the means for determining if the current is below the predetermined value and the voltage is below the higher threshold and the means for determining if the current is above the predetermined value and the voltage is below the lower threshold, are implemented by a controller.

7. The battery management system of claim 1, further comprising a means for resetting, the means for resetting reconnecting the battery cells to the load by the means for switchably disconnecting.

8. A method of managing one or more battery cells, the method comprising the steps of:
(a) electrically connecting the battery cells to a load;
(b) measuring an electric current from the battery cells to the load;
(c) if the electric current is greater than a predetermined value:
(d) starting a timer;
(e) if the electric current is still greater than the predetermined load and a voltage over the battery cells is greater than a lower threshold, repeating from step (a);
(f) if the timer has not expired, repeating steps (e)-(f);
(g) electrically disconnecting the battery cells from the load;
(h) waiting until a reset occurs;
(i) repeating from step (a);
(j) if the electric current is less than the predetermined value:
(k) starting the timer;
(l) if the electric current is still less than the predetermined load and the voltage over the battery cells is greater than a higher threshold, repeating from step (a);
(m) if the timer has not expired, repeating steps (l)-(m);
(n) electrically disconnecting the battery cells from the load;
(o) waiting until a reset occurs;
(p) repeating from step (a).

9. The method of claim 8, wherein the step (a) connecting also includes turning off an indicator.

10. The method of claim 9, wherein the step (g) disconnecting also includes turning on the indicator.

11. The method of claim 9, wherein the step (n) disconnecting also includes turning on the indicator.

12. The method of claim 8 wherein the higher threshold is 10 volts and the lower threshold is 8 volts.

13. A battery management system comprising:
one or more transistors connected in series between a plurality of battery cells and a load;
a sensor for measuring an electric current between the battery cells and the load;
a sensor for measuring a voltage over the battery cells;
a processor, the processor connected to the transistors for connecting and disconnecting the load and the battery cells, the processor connected to the sensor for measuring the electric current and the sensor for measuring the voltage, the processor having stored values for a lower voltage threshold and a higher voltage threshold;
software running on the processor determines if the electric current is below a predetermined value and if the voltage is below the higher voltage threshold and signals the transistors to disconnect the battery cells from the load when the electric current is below the predetermined value and the voltage is below the higher voltage threshold; and
the software also determines if the electric current is above the predetermined value and the voltage is below the lower voltage threshold and signals the transistors to disconnect the battery cells from the load when the electric current is above the predetermined value and the voltage is below the lower voltage threshold.

14. The battery management system of claim 13, wherein the software includes a timer and the software signals the transistors to disconnect the battery cells from the load when the electric current is below the predetermined value and the voltage is below the higher voltage threshold for an interval determined by the timer.

15. The battery management system of claim 13, wherein the software includes a timer and the software signals the transistors to disconnect the battery cells from the load when the electric current is above the predetermined value and the voltage is below the lower voltage threshold for an interval determined by the timer.

16. The battery management system of claim 13, wherein the transistors are parallel pairs of field effect transistors, the transistors in each pair arranged in series and a first transistor of each pair is in parallel with at least one diode arranged in a first polarity and a second transistor of each pair is in parallel with at least one diode arranged in an opposite polarity.

17. The battery management system of claim 13, wherein the transistors are field effect transistors controllably driven into saturation by a charge pump, the charge pump interfaced between the processor and the gates of the transistors.

18. The battery management system of claim 13, further comprising a temperature sensor, the temperature sensor measuring a surface temperature of at least one of the battery cells and the temperature sensor connected to the processor, the software further comparing the surface temperature with an internal temperature threshold and if the surface temperature is greater than the internal temperature threshold, the software signals the transistors to disconnect the battery cells from the load.

19. The battery management system of claim 13, the processor further comprising a reset input, the software reads the reset input and when a reset signal is received, the software signals the transistors to reconnect the battery cells to the load.

20. The battery management system of claim 13, wherein the lower voltage threshold is 8 volts and the higher voltage threshold is 12 volts.
